(19) United States
(12) Patent Application Publication
(10) Pub. No.: US 2014/0170598 A1
(43) Pub. Date: Jun. 19, 2014

(54) Unknown

(71) Applicant: BEGO Bremer Goldschlägerel Wilh, Herbst GmbH & Co. KG, (US)

(72) Inventor: Ulrich ABEND, Schwanewede (DE)

(73) Assignee: BEGO Bremer Boldsclägerei Wilh, Herbst GmbH & Co. KG, Bremen (DE)

(21) Appl. No.: 13/714,638

(22) Filed: Dec. 14, 2012

(51) Int. Cl. A61C 13/08; B23K 26/34; A61C 13/09; C22C 19/07

(52) U.S. Cl. CPC A61C 13/081; C22C 19/07; B23K 26/345; A61C 13/09
USPC 433/208; 420/588; 219/121.66

(57) ABSTRACT

The present invention relates to a cobalt-based noble-metal dental alloy for the SLM process, which is intended for the production of metallic components, a corresponding method of producing a metallic component and a corresponding metallic component.

The present invention relates to a cobalt-based noble-metal dental alloy for the SLM process, which is intended for producing metallic components, a corresponding method of producing a metallic component and a corresponding metallic component. The metallic component is preferably intended as or for a dental restoration and is more preferably a dental structure as or for a dental restoration, preferably consisting of a noble-metal dental alloy according to the invention.

Another aspect of the present invention relates to a powder comprising or consisting of particles of the noble-metal dental alloy according to the invention for use in a selective laser melting (SLM) process, and the use of the powder according to the invention of a in noble-metal dental alloy according to the invention for producing a metallic component by an SLM process, preferably for producing a metallic, component as or for a dental restoration by an SLM process.

The SLM process (SLM stands for selective laser melting) is a generative manufacturing process, which belongs to the group of beam melting processes. In the SLM process, after selective application of material or non-selective application of material, selective processing of the applied material takes place (determination of geometry by or during selective laser melting). For selective application of material, the material to be processed is usually pressed in a wire-like form through a moving nozzle. The selectively applied material is the melted selectively using a laser (determination of geometry by selective application of material and selective laser melting). At present, however, in practice processes with non-selective application of a powder are more common. In this, based on computer-assisted data models, a laser selectively transmits information on the geometry of a component to be fabricated, to a non-selectively applied starting material in powder form, the particles of which are completely melted locally by the energy of the laser. After solidification, a solid layer of material forms, on which, in the next process step, powder is again applied non-selectively and the melting and solidification process is repeated. This cycle is repeated until all the layers have been applied.

Building up in layers by selective laser melting is described for example in WO 2010/003882 A2.

A device and a method for producing a three-dimensional object are described in principle in EP 0 734 842 A1, the disclosure of which in this respect is incorporated completely in the present text (reference is made in particular to paragraphs [0024] through [0029]).

The SLM process allows rapid production of complex and in particular individual components, the conventional manufacture of which (i.e. conventional primary forming, for example casting processes or chip-removal processes (subtractive processes)) is not possible or is only possible at great expense. The SLM process can be used very flexibly, so that it is in particular suitable for making models, patterns, prototypes, tools, and for the manufacture of short runs or individual components (e.g. metallic components for dental restorations for an individual patient), without having to make a mould first. Applications are known for example from the following documents: EP 2 289 652 A1, WO 2012/076205 A1, EP 1 568 472 B1, DE 103 20 085 A1, WO 2010/003882 A2 and EP 2 289 462 B1.

A noble-metal dental alloy in the sense of the present invention is, in accordance with a definition of the American Dental Association (ADA), an alloy that has a noble metal content greater than or equal to 25 wt. % (according to “Revised Classification System for Alloys for Fixed Prosthodontics”), wherein the noble metals according to the ADA definition include exclusively gold and platinum group elements (ruthenium, rhodium, palladium, osmium, iridium, platinum).

The noble-metal dental ahoy according to the invention for the SLM process is a noble metal-containing (i.e. containing noble metals selected from the group consisting of so ruthenium, rhodium, palladium, osmium, iridium and platinum), preferably palladium-containing, cobalt-based alloy (i.e. the proportion by weight of cobalt in an alloy according to the invention is greater than each proportion by weight of the remaining alloying constituents).

Noble metal-containing alloys that contain cobalt are known for example from the following documents:

DE 11 04 195 (DBP 11 04 195) discloses deformable, corrosion-resistant cobalt-chromium alloys, characterized in that they consist of 20 through 45% cobalt, 20 through 40% chromium and 20 through 50% ruthenium.

DE 30 09 650 C2 discloses the use of an alloy of 1 through 70% palladium, 0.1 through 35% chromium 0 through 20% molybdenum and/or tungsten, remainder cobalt, for it) veneering with dental ceramics, with the proviso that it additionally contains up to 1% boron.

DE 10 2005 062 837 A1 discloses a dental alloy based on iron, cobalt and/or nickel, which contains at least 25% gold and/or platinum group elements, wherein ruthenium forms the major proportion of these noble metals.

DE 101 36 997 A1 discloses a cobalt dental alloy with at least one noble metal, wherein the proportion of noble metal is more than 15-35 wt. %, and with the proviso that palladium is not contained atone.

U.S. Pat. No. 6,756,012 B2 discloses a cobalt-chromium dental alloy, comprising cobalt (approx. 60 through approx. 85%), chromium (approx. 15 through approx. 30%), manganese (approx. 4 through approx. 20%) and approx. 1 through 15% aluminum, indium, gallium, tin or germanium or mixtures thereof, and wherein the coefficient of thermal expansion at room temperature up to about 500° C. is 16 through 18×10⁻⁶/° C.

EP 0 225 668 B1 discloses palladium-cobalt alloys, containing 40 through 60% palladium, 20 through 59% cobalt and 0 through 40% nickel.

US 2005/0158693 A1 discloses a dental alloy comprising approx. 5 through approx. 30% chromium, approx. 0.1 through approx. 25% of one or a plurality of the elements manganese, gallium indium, tin, germanium and zinc, approx 0.1 through approx. 10% of one or a plurality of the elements aluminum and silicon, and the remainder is iron.

US 2011/0275033 A1 discloses a dental ahoy based on palladium-cobalt. This comprises for example palladium (approx. 20 through approx. 36.7 wt. %), cobalt (approx. 38 through approx. 54 wt. %), chromium (approx. 16 through approx. 22 wt. %), gold (approx. 0.1 through approx. 5 wt. %) and molybdenum (0 through approx. 12.9 wt. %).

WO 2008/033366 A2 discloses an alloy based on palladium-cobalt. This comprises for example palladium (approx. 20 through approx. 90%), cobalt (approx. 10 through approx. 80%) and further alloying constituents, for example chromium.

WO 2008/115879 A1 discloses a non-magnetic cobalt-palladium dental alloy. This usually contains at least 26 wt. % palladium, 15 through 30 wt. % chromium and cobalt.

A number of cobalt-based noble metal alloys are commercially available.

However, it was found in our own tests that the alloys known from the prior art often have a tendency, to an extent that is no longer acceptable, to form hot cracks (previously also called “hot cracking”), when they are used in SLM processes.

Hot cracks are, according to DVS 1004-1 “Hot-crack test methods—Principles” (November 1996) of the Deutscher Verband für Schweisstechnik E.V. [German Association for Welding Technology], separations in materials that run along the grain boundaries (dendrite boundaries), i.e. are intercrystalline (interdendritic). Hot cracks can develop for example when in a largely solidified body (for example produced from an alloy), small residues of a liquid phase are still present (for the causes, see below). Formation of hot cracks therefore takes place at temperatures that are between the solidus and the liquidus temperature. The solidus temperature is the temperature at which and below which the alloy is completely in the solid phase, whereas the liquidus temperature is the temperature at which and above which the alloy is completely in the liquid phase. The temperature difference Delta T_{L-S} (ΔT_{L-S}) between solidus (T_{S}) and liquidus temperature (T_{L}) is known as the melting range or also as the solidification range. Within the melting range the alloy is paste-like, solid and liquid phases coexist, making possible or promoting the formation of hot cracks. If the liquidus temperature and the solidus temperature in an alloy coincide, it is for example a eutectic alloy. The transition from the liquid to the solid state is in this case sudden and is known as the eutectic point.

If the melting ranges of two alloys are compared, then, as was found in our own investigations, the alloy that has a larger (i.e. wider) melting range is generally more prone to form hot cracks than the alloy with the smaller (i.e. narrower) melting range.

One cause of hot cracks is the volume contraction (or solidification shrinkage), such as occurs with most metallic materials during cooling and/or solidification. If this contraction is hampered (for example through faster solidification of thinner cross-sections than thicker cross-sections, which cool and/or solidify more slowly), there is basically a risk of hot cracks forming.

Generally those alloys are considered to be the least sensitive to the formation of hot in cracks in which, towards the end of solidification, there is a notable amount of eutectic melt of an alloy, i.e. solidifying at constant temperature (eutectic point), because at a constant temperature the solidification shrinkage is distributed uniformly over a large volume (high proportion of residual melt).

A person skilled in the art describes a state for example as crack-free, when in a metallographic polished section of a metallic component (e.g., by preparing a section that is polished to a high gloss and examining it in direct-light microscopy) at a magnification of 100, no crack (or notch or fissure) can be seen with a length greater than 50 micrometers starting from the component surface. Instructions for preparation are given in the Metalog Guide (Bjerregaard, Geels, Ottesen, Rückert, Struers A/S, Copenhagen, Denmark, 2000).

For designing new cobalt-based noble-metal dental alloys, a person skilled in the art must take into account a large number of other technical properties and must try to adjust selected properties particularly favorably, without any particularly adverse effect on the other properties. These properties include in particular the mechanical properties of the alloy. However, in addition to the mechanical properties, it is also necessary to pay attention to the chemical and biological properties.

The mechanical properties of an alloy include for example properties such as hardness, high-temperature strength, coefficient of thermal expansion (CTE) and mechanical strength (usually described on the basis of parameters such as elastic modulus, 0.2% proof stress, tensile strength, elongation at break). A person skilled in the art knows suitable methods for determining the aforementioned properties (for example based on DIN-EN-ISO-22674:2006 and ISO 9693). The 0.2% proof stress (Rₚ 0.2) is the stress applied to a body, which produces a small deformation (=0.2% residual deformation) after removal of the load.

The relevant chemical properties of a dental alloy according to the invention include in particular corrosion resistance and the presence of or the susceptibility to discoloration. Discoloration may occur in particular when for example a ceramic is fired to the alloy. The formation of metal oxides may in this case cause undesirable discoloration.

The biological properties (toxic or allergic reactions) depend mainly on the corrosion behavior. High corrosion resistance gives rise to reduced release of ions or to release of ions within a concentration range that is biologically acceptable. Minimum possible release of ions is preferred. However, the nature of the ions released must also be taken into account. For example, copper and silver ions have bactericidal action, which is to be regarded as entirely positive in an individual case. However, with increasing concentration these elements have cytotoxic action, and may cause local toxic reactions.

A primary object to be achieved by the present invention was to provide a cobalt-based noble-metal dental alloy, which when used in SLM processes has no or only a slight tendency to form hot cracks and moreover has some or all of the aforementioned positive mechanical, biological and/or chemical properties. A noble-metal dental alloy to be provided for the SLM process should preferably be suitable for veneering and Therefore should have a favorable coefficient of thermal expansion. Preferred noble-metal dental alloys that are to be provided should have:
a CTE of 14.1 through 14.9 [10⁻⁶K⁻¹] in a range from 25 through 500° C.,
   and/or
tensile strength>700 MPa,
   and/or
a proof stress (Rₚ 0.2)>500 MPa,
   and/or
an elongation at break>2%,
   and/or
HV 10 (Vickers hardness) in the range from 300 through 400
   and/or
a melting range, wherein the difference Delta T_{L-S} (ΔT_{L-S}) between solidus and liquidus temperature should preferably be only 70 K or less. Regarding the individual parameters and their significance, see the text hereunder.

The aforementioned mechanical properties were determined on suitable test specimens (see examples, point 2.).

Particularly preferred noble-metal dental alloys that are to be provided should have a plurality of or all of the aforementioned properties (i.e. a CTE of 14.1 through 14.9 [10⁻⁶K⁻¹] in a range from 25 through 500° C. and a tensile strength>700 MPa and a proof stress (Rₚ 0.2)>500 MPa and an elongation at break>2% and HV 10 in the range from 300 in through 400 and a melting range, wherein the difference Delta T_{L-S} (ΔT_{L-S}) between solidus and liquidus temperature should preferably be only 70 K or less). Noble-metal dental alloys with a melting range of only 70 K or less regularly possess a narrower melting range than noble-metal dental alloys for casting processes.

This primary object is achieved according to the invention with a noble-metal dental alloy for the SLM process, consisting of

| | |
|---|---|
| cobalt in an amount of | 36 through 47 wt. %, |
| one, two or a plurality of noble metals | 25 through 35 wt. %, |
| selected from the group consisting of | |
| ruthenium, rhodium, palladium, osmium, | |
| iridium and platinum, wherein the | |
| total amount of these noble metals is | |
| chromium in an amount of | 22 through 29 wt. %, |
| one or both elements from the group | 6 through 11 wt. %, |
| consisting of molybdenum and tungsten, | |
| wherein the total of the amount of | |
| molybdenum and half the amount of tungsten is | |
| boron in an amount of | 0 through 0.05 wt. % |
| | or |
| | 0.2 through 0.75 wt. %, |
| one, two, more than two or all elements | 0 through 0.5 wt. %, |
| selected from the group consisting of | |
| niobium, tin, silicon, aluminum, tantalum, | |
| cerium, indium, vanadium, titanium, | |
| zirconium, hafnium, rhenium and manganese, | |
| wherein the total amount of these elements is | |
| and | 0 through 2 wt. %, |
| one or a plurality of other elements | |
| in a total amount of | |

wherein the percentages by weight are in each case relative to the total weight of the noble-met al dental alloy,
wherein the following is valid:
the sum of 2.6 times the amount of molybdenum and 1.3 times the amount of tungsten and the amount of chromium is in the range from 40 through 50 wt. %.

The noble-metal dental alloy according to the invention as described above) comprises
cobalt,
one, two or a plurality of noble metals selected from the group consisting of ruthenium, rhodium, palladium, osmium, iridium and platinum,
chromium,
molybdenum and/or tungsten,
optionally boron,
optionally one, two, a plurality of or all elements selected from the group consisting of niobium, tin, silicon, aluminum, tantalum, cerium, indium, vanadium, titanium, zirconium, hafnium, rhenium and manganese, and
optionally other elements.

In every case the alloy comprises cobalt, one, two or a plurality of noble metals (selected from the group consisting of ruthenium, rhodium, palladium, osmium, iridium and platinum), chromium and molybdenum and/or tungsten. The sum of 2.6 times the amount of molybdenum and 1.3 times the amount of tungsten and the amount of chromium is in the range from 40 through 50 wt. %. A good compromise between the mechanical properties (such as hardness, strength and brittleness), corrosion resistance and so coefficient of thermal expansion is found in this range.

A noble-metal dental alloy (as described above) for the SLM process is preferred, wherein
the weight ratio of molybdenum to tungsten is greater than 2:1, preferably is greater than 10:1, particularly preferably is greater than 50:1,
   and/or
the proportion of tungsten in the noble-metal dental alloy is less than 6 wt. %, preferably is less than 3 wt. %, particularly preferably is less than 1 wt. %, quite particularly preferably is in the range from 0 through 0.4 wt. %.

In a preferred noble-metal dental alloy according to the invention, tungsten is therefore less preferred compared with molybdenum, namely because in our own investigations it was found that in some cases tungsten increases the tendency to form hot cracks somewhat, compared with preferred noble-metal dental alloys according to the invention, which contain no or only very small proportions of tungsten. Our own investigators showed, in an overwhelming number of cases, the following: the tendency to form hot cracks is particularly pronounced when the weight ratio of molybdenum to tungsten is well below 2:1 and/or the proportion of tungsten in the noble-metal dental alloy is well above 6 wt %. If the weight ratio of molybdenum to tungsten is 2:1 to 10:1 and/or if the proportion of tungsten in the noble-metal dental alloy is 3 through 6 wt. %, the tendency to form hot cracks is still perceptible, but it is only particularly pronounced in a few cases. It has been found that when the weight ratio of molybdenum to tungsten is 10:1 to 50:1 and/or the proportion of tungsten in the noble-metal dental alloy is in an amount from 1 through 3 wt. %, the tendency to form hot cracks is in most cases slight and therefore is acceptable. Crack-free SLM products are regularly obtained when the weight ratio of molybdenum to tungsten is above 50:1 and/or the proportion of tungsten in the noble metal dental alloy is in the range from 0 through 0.4 wt. %.

In a preferred noble-metal dental alloy according to the invention (as described above and preferably designated above as preferred), the two constituents chromium and molybdenum are contained at a concentration that is, on the one hand, as high as possible, but on the other hand is set low enough so that the precipitation or formation of a brittle intermetallic compound is avoided. This ensures good corrosion resistance or optimum biocompatibility. Our own investigations have shown that the aforementioned conditions are fulfilled when the sum of 2.6 the amount of molybdenum and 1.3 times the amount of tungsten and the amount of chromium is in the range from 40 through 50 wt. %. Said noble-metal dental alloy according to the invention for the SLM process (as described above and preferably designated above as preferred) is in many cases characterized in that after laser melting it forms no or at least only few hot cracks.

A noble-metal dental alloy according to the invention for the SLM process (as described above and preferably designated above as preferred) is particularly preferred, comprising

| | |
|---|---|
| cobalt in an amount of | 36 through 46.5 wt. %, |
| | preferably 37 through 45 wt. %, |
| and/or | 25 through 30 wt. %, |
| one, two or a plurality of noble metals | preferably 25 through 28 wt. %, |
| selected from the group consisting of | |
| ruthenium, rhodium, palladium, | |
| osmium, iridium and platinum, wherein | |
| the total amount of these noble metals is | |
| and/or | 22.5 through 28 wt. %, |
| chromium in an amount of | preferably 23 through 27 wt. %, |
| and/or | 6.5 through 10 wt. %, |
| one or both elements from the group | preferably 7 through 9.5 wt. %, |
| consisting of molybdenum and tungsten, | |
| wherein the total of the amount of | |
| molybdenum and half the amount of | |
| tungsten is | |
| and/or | 0 through 15 wt. %, |
| a total amount of the one or the | preferably 0 through 1 wt. %, |
| plurality of other elements in the range | |
| from | |

wherein the percentages by weight are in each case relative to the total weight of the noble-metal dental alloy.

In a noble-metal dental alloy according to the invention for the SLM process, the cobalt content (relative to the total weight of the noble-metal dental alloy) is 36 through 47 wt. %, so that an acceptable compromise is achieved between undesirable embrittlement and strength. A noble-metal dental alloy according to the invention (as described above and preferably designated above as preferred) preferably comprises

| | |
|---|---|
| cobalt in an amount of | 36 through 46.5 wt. %, |
| preferably | 37 through 45 wt. %, |
| particularly preferably | 38.75 through 43 wt. %, |
| most preferably | 40.5 through 42 wt. %. |

It was found in our own investigations that a cobalt content of more than 47 wt. % often leads to undesirably reduced strength. Starting from a total proportion of more than 47 wt. % this effect is particularly pronounced and often unacceptable, in the range (according to the invention) from 47 through 46.5 wt. %, a reduced strength in noble-metal dental alloys according to the invention is in some cases still perceptible. If cobalt is present in a proportion by weight from 46.5 through 45 wt. %, this effect is in most cases already acceptable for practical application. A cobalt content of from 45 through 43 wt. % (or from 43 through 42 wt %) in many cases displays good (or in almost all cases excellent) strength.

However, a cobalt content of less than 36 wt. % often leads to an alloy with undesirable embrittlement, in particular when the alloy comprises a high proportion of chromium to make up for the small amount of cobalt. If the concentration is below 36 wt. %, this effect is particularly pronounced. If the cobalt concentration is in a range from 36 through 37 wt. %, pronounced embattlement is only observed in isolated cases. In the range from 37 through 38.75 wt %, the effect of embrittlement is in almost all cases already acceptable for practical application. In most cases (or in almost all cases) good strength is achieved, without undesirable embrittlement occurring, when cobalt is present in a range from 38.75 through 40.5 wt. %.

A particularly good compromise of strength and embrittlement is regularly achieved with noble meal dental alloys according to the invention for the SLM process with a cobalt content in the range from 40.5 through 42 wt. %. Acceptable compromises are, however, already achieved in the wider concentration ranges as defined above. A preferred noble-metal dental alloy according to the invention as described above and preferably designated above as preferred) comprises a proportion from 25 through 35 wt. % palladium, or a mixture of palladium with one or a plurality of the other noble metals selected from the group consisting of ruthenium, rhodium, osmium, indium and platinum.

It was found in our own investigations that a total amount of noble metals selected from the group consisting of ruthenium, rhodium, palladium, osmium, iridium and platinum of at least 25 wt. % regularly leads to very good oral stability, i.e. in a test based on DIN-EN-ISO-22674:2006, no significant susceptibility to corrosion was found that leads to undesirable solubility of the alloy in the oral cavity.

A person skilled in the art can determine the corrosiveness of an alloy from
(i) the electrochemically measured “open circuit potential” (measurement of the open circuit potential, based on DIN-EN-ISO 10271:2011)
   or
(ii) the “zero-current potential” (based on ISO 10271)
   or
(iii) an elemental analysis (static immersion testing, based on ISO 10271).

Palladium is an economical alternative to platinum for example. According to a preferred embodiment, a noble-metal dental alloy according to the invention for the SLM process (as described above and preferably designated above as preferred) is preferred, wherein the proportion of palladium in the noble metals selected from the group consisting of ruthenium, rhodium, palladium, osmium, indium and platinum is greater than 50 wt. %, preferably is greater than 75 wt. %, particularly preferably is greater than 95 wt. % and in particular preferably is in a range from 99.9 through 100 wt. %, relative to the total weight of said noble metals in the noble-metal dental alloy.

According to another preferred embodiment, a noble-metal dental alloy according to the invention for the SLM process (as described above and preferably designated above as preferred) preferably comprises

| | |
|---|---|
| palladium in an amount of | 25 through 33.5 wt. %, |
| preferably | 25 through 30 wt. %, |
| particularly preferably | 25 through 28 wt. %, |
| most preferably | 25 through 25.5 wt. %. |

A higher palladium content generally leads to a (undesirable) cost increase of the noble-metal dental alloy according to the invention. In addition, the following was found in our own investigations: A palladium content of more than 35 wt. % regularly leads to undesirable formation of hot cracks, with increased occurrence. Similar results were also observed when a noble-metal dental alloy according to the invention comprises one, two or a plurality of noble metals selected from the group consisting of ruthenium, rhodium, palladium, osmium, iridium and platinum in a total amount above 35 wt %.

In a concentration range from 35 through 33.5 wt. %, this effect is still perceptible, but is particularly pronounced only in very few cases. In the concentration range from 33.5 through 30 wt. % the tendency to form hot cracks is in many cases already acceptable for practical application. If palladium is present at a concentration from 30 through 28 wt. %, crack-free noble-metal dental alloys are regularly obtained. Primarily crack-free noble-metal dental alloys are obtained when palladium is present at a concentration of 28 through 25.5 wt. %. Crack-free noble-metal dental alloys are of course obtained in particular when the cobalt content is also in a preferred range (as defined above) and the concentrations of the other constituents are also in preferred ranges (as defined in the present text).

If the palladium content in a preferred noble-metal dental alloy according to the invention is at least 25 wt. %, in particular 25 through 35 wt. %, a good compromise between corrosion resistance and formation of hot cracks can regularly be achieved by adjusting the concentrations of the other alloying constituents.

For cobalt-based alloys with a noble metal content of 25 wt. % or more, compared to cobalt-based alloys not containing noble metals, a more-positive open circuit potential or zero-current potential has been measured, which is interpreted as “more noble” behavior, and improved oral stability is correspondingly to be expected.

A particularly good compromise of (a) reduced formation of hot cracks and (b) corrosion resistance is regularly achieved with preferred noble-metal dental alloys according to the invention with a palladium content in the range from 25 through 25.5 wt. %, in particular when the cobalt content is also in a preferred range (as defined above) and the concentrations of the other constituents are also in preferred ranges (as defined in the present text). Acceptable compromises are, however, already achieved in the wider concentration ranges, as defined above.

The configurations designated above as preferred also apply to noble metals selected from the group consisting of ruthenium, rhodium, osmium, iridium and platinum and mixtures thereof.

In a noble-metal dental alloy according to the invention for the SLM process (as described above and preferably designated above as preferred) the proportion of chromium is 22 through 29 wt. %, so that an acceptable compromise can be found in between corrosion resistance, formation of hot cracks, coefficient of thermal expansion and brittleness. A noble-metal dental alloy according to the invention (as described above and preferably designated above as preferred) preferably comprises

| | |
|---|---|
| chromium in an amount of | 22.5 through 28 wt. %, |
| preferably | 23 through 27 wt. %, |
| particularly preferably | 24 through 26 wt. %, |
| most preferably | 24 through 25.5 wt. %. |

It was found in our own investigations that a chromium content of less than 22 wt. % often leads to an unacceptable, high corrosiveness of the corresponding alloy and therefore to solubility thereof in the oral cavity. In addition it was found that a chromium content of less than 22 wt. % leads to an increase in the formation of undesirable hot cracks in the preparation of samples by SLM. If the concentration is below 22 wt. %, these effects are particularly pronounced. If chromium is present in a concentration range from 22 through 22.5 wt. %, the effects are still perceptible and are only particularly pronounced in isolated cases. If chromium is present in the range from 22 through 23 wt. %, the corrosion resistance and the tendency to form hot cracks are in most cases already acceptable for practical application. Mainly crack-free alloys with regularly good corrosion resistance are obtained when the chromium content is 23 through 24 wt %.

A proportion greater than 29 wt. % leads in individual cases (i) to an alloy that suffers unacceptable embrittlement (in particular, the elongation at break decreases with increasing chromium content) and (ii) to an unacceptable increase in hardness of the alloy, with a negative influence on mechanical processing (grinding/milling). This effect is particularly pronounced starting from a concentration greater than 29 wt. %. If the proportion of chromium is 29 through 28 wt. %, the negative effects are still noticeable but a only particularly pronounced in a few cases. If chromium is present in a concentration range from 28 through 27 wt. %, in most cases the resultant embrittlement or hardness of the noble-metal dental alloy according to the invention may be acceptable for practical application. If the proportion of chromium is 27 through 26 wt. %), there is regularly a noticeable decrease in the negative effects and mainly noble-metal dental alloys with good elongation at break and hardness can be produced. In most cases, elongation at break and hardness can be particularly advantageous when the chromium content is in the range from 26 through 25.5 wt. %.

Noble-metal dental alloys with preferred properties are naturally obtained in particular when the cobalt content and the noble metal content, in particular the palladium content, are also in a preferred range (as defined above) and the concentrations of the other constituents are also in preferred ranges (as defined in the present text).

A particularly good compromise of corrosion resistance, embrittlement, coefficient of thermal expansion and hardness is regularly achieved with noble-metal dental alloys according to the invention with a chromium content in the range from 24 through 25.5 wt. %, in particular when the cobalt content and the noble metal content, preferably the palladium content, are also preferably in each case in a preferred range (as defined above) and the concentrations of the other constituents are also in preferred ranges (as defined in the present text). Acceptable compromises are, however, already achieved in the wider concentration ranges, as defined above.

A noble-metal dental alloy according to the invention comprises a proportion of molybdenum and tungsten wherein the sum of the amount of molybdenum and half the amount of tungsten is 6 through 11 wt. %. If molybdenum and tungsten are used simultaneously, preferably the foregoing statements with respect to the weight ratio of molybdenum to tungsten apply (see above).

According to a preferred embodiment a noble-metal dental alloy according to the invention (as described above and preferably designated above as preferred) preferably comprises

| | |
|---|---|
| molybdenum in an amount of | 6.5 through 10 wt. %, |
| preferably | 7 through 9.5 wt. %, |
| particularly preferably | 7.5 through 9.3 wt. %, |
| quite particularly preferably | 8 through 9.3 wt. %, |
| most preferably | 8.5 through 9.2 wt. %. |

It was found in our own investigations that a molybdenum content in the range from 6 through 11 wt. % can lead to acceptable hardness, tensile strength, elongation at break and, to a certain extent, coefficient of thermal expansion. A total content of molybdenum of less than 6 wt. % in a noble-metal dental alloy according to the invention leads in individual cases (i) to an unacceptable, high susceptibility to corrosion of the corresponding alloy, in particular in an acidic environment (formation of an inadequate passivation layer, which protects against corrosion), in particular in crevices (“crevice corrosion”, corrosion in or near a narrow gap or a narrow opening) and therefore also (ii) to undesirable solubility of the corresponding alloy in the oral cavity. These effects are particularly pronounced if the concentration is below 6 wt. %. If the proportion of molybdenum in preferred noble-metal dental alloys according to the invention (as described above and preferably designated above as preferred) is in the range from 6 through 6.5 wt. %, the negative effects are still noticeable, but are only particularly pronounced in isolated cases. In a concentrator range from 6.5 through 7 wt. %, in many cases hardness, tensile strength and elongation at break are acceptable for practical application. If molybdenum is present in a concentration from 7 through 7.5 wt. % (or from 7.5 through 8 wt. %), there is regularly a noticeable decrease in the negative effects (i.e. alloys with advantageous hardness, tensile strength and elongation at break can often be obtained). Primarily crack-free noble-metal dental alloys, with particularly advantageous values of hardness, tensile strength and elongation at break, are obtained when molybdenum is contained at a concentration from 8 through 8.5 wt. %.

Moreover, it was found in our own investigations that a total proportion of more than 11 wt. % of molybdenum leads in individual cases (i) to a corresponding alloy that has severe embrittlement, owing to increased occurrence of a precipitated phase (decrease in particular of elongation at break) and (ii) to an increase in hardness with negative influence on mechanical processing (grinding/milling); moreover (iii) an increase in the formation of undesirable hot cracks was observed in the preparation of samples by SLM. If the proportion of molybdenum is 11 through 10 wt. % (at a molybdenum content of 11 wt. %, the alloy does not contain any tungsten), the negative effects of the properties described under (i) and (ii) are still noticeable, but are particularly pronounced in very few cases. If the proportion of molybdenum is in the range from 10 through 9.5 wt. % (or from 9.5 through 9.3 wt. %), in many (or in most) cases embrittlement and hardness acceptable for practical application are already achieved. A particularly advantageous and desirable elongation at break or hardness is achieved when molybdenum is contained at a concentration from 9.3 through 9.2 wt. %.

Our own investigations have shown that the effects of molybdenum (as well as those of tungsten) are very similar in many respects to those of chromium in an alloy according to the invention. Both elements show both an influence on corrosion behavior and hardness/brittleness and a pronounced influence on the coefficient of thermal expansion (CTE). It is therefore clear to a person skilled in the art that the proportions of the two elements must be adjusted appropriately, for the CTE of the resultant alloy to be in the compatibility range of common veneer ceramics. In each case: increasing the proportion of chromium and/or molybdenum decreases the CTE of the resultant alloy according to the invention.

In particularly preferred embodiments, no tungsten is used, as tungsten causes a slight increase in tendency to form hot cracks. In other preferred embodiments molybdenum is replaced partially or completely with tungsten. In that case the foregoing preferably applies (in particular concerning the weight ratio of molybdenum to tungsten). If (starting from a tungsten-free alloy) molybdenum is replaced with tungsten, the resulting noble-metal dental alloy according to the invention comprises a doubled content of tungsten, compared with the molybdenum content that is replaced with tungsten.

Noble-metal dental alloys with preferred properties are then naturally obtained in particular when, in addition to the molybdenum content (and/or optionally tungsten content), the cobalt content, noble metal content (in particular the palladium content) and chromium content are in a preferred range (as defined above) and the concentrations of the other constituents are also in preferred ranges (as defined in the present text).

A particularly good compromise of corrosion resistance, embrittlement, coefficient of thermal expansion and hardness as well as with respect to particularly advantageous values of hardness, tensile strength and elongation at break is regularly achieved with noble-metal dental alloys according to the invention with a molybdenum content in the range from 8.5 through 9.2 wt. %, in particular when the cobalt content, the palladium content and the chromium content are in each case in a preferred range (as defined above) and the concentrations of the other constituents are also in preferred ranges (as defined in the present text). Acceptable compromises are, however, already achieved in the wider concentration ranges, as defined above.

In other preferred embodiments, acceptable compromises are already achieved when the sum of the amount of molybdenum and half the amount of tungsten is 6.5 through 10 wt. %. Good results are regularly achieved when the sum of the amount of molybdenum and half the amount of tungsten is 7 through 9.5 wt. %.

In a noble-metal dental alloy according to the invention for the SLM process the proportion of boron is 0 through 0.05 or 0.2 through 0.75 wt. %, relative to the total weight of the noble-metal dental alloy. A noble-metal dental alloy according to the invention for the SLM process (as described above and preferably designated above as preferred) preferably comprises boron in an amount from 0 through 0.03 wt. %, preferably 0 through 0.02 wt. % or 0.2 through 0.6 wt. %, preferably 0.25 through 0.4 wt %, wherein the percentages by weight are in each case relative to the total weight of the noble-metal dental alloy.

Our own investigations have shown that boron, in certain concentrations, can have a favorable effect on the melt viscosity (flow behavior) and the melting range (temperature interval between solidus and liquidus temperature; in the melting range, solid and liquid phases coexist; see also the account given above) and the melting behavior of a noble-metal dental alloy according to the invention. In addition, boron (if present) in many cases promotes good bonding to usual veneer ceramics. Our own investigations have also shown, however, that the boron content should be adjusted precisely, as the boron content has a marked effect not only on the adherence properties, but also on the mechanical properties and in some concentrations even has an adverse effect on the melting range, see below.

It was found in our own investigations that a boron content of more than 0.75 wt. % leads in isolated cases, through intensified for excessive) formation of precipitates, to an undesirable increase in hardness of the alloy, with simultaneous embrittlement (in particular, the elongation at break decreases with increasing boron content). In particular in conjunction with SLM processes, there is often a large volume change during solidification and a pronounced tendency to produce distortion. This effect is very pronounced in particular when the total proportion of boron exceeds 0.75 wt. %. If boron is present in a noble-metal dental alloy (according to the invention) in a range from 0.75 through 0.6 wt. %, hardness, brittleness and formation of distortion may in many cases already be acceptable for practical application. In a concentration range from 0.6 through 0.4 wt. %, mainly crack-free noble-metal dental alloys according to the invention can already be produced, which in addition have in most cases an advantageous hardness or little formation of distortion (i.e. deformation or warping).

Noble-metal dental alloys with preferred properties are then naturally obtained in particular when, in addition to the boron content, the cobalt content, the noble metal content it particular the palladium content), the chromium content and the molybdenum content (and/or optionally tungsten content) are also in a preferred range as defined above) and the concentrations of the other constituents are also in preferred ranges as defined in the present text).

A particularly good compromise of melting range, viscosity and embrittlement is regularly achieved with noble-metal dental alloys according to the invention with a boron content in the range from 0 through 0.02 or 0.25 through 0.4 wt. %. Acceptable compromises are, however, already achieved in the wider concentration ranges, as defined above.

A boron content in the range between the stated limits (according to the invention) of 0.05 and 0.2 wt. % is undesirable, because corresponding boron contents regularly extend the melting range, which has an adverse effect on the tendency to form hot cracks.

As boron is contained in the noble-metal dental alloy according to the invention in defined concentrations (preferably in the concentrations designated as preferred), it regularly contributes very effectively to a small melting range and to a low viscosity of the melt, without already notably reducing the corrosion resistance or causing embrittlement of the alloy. Furthermore, a small melting range contributes to avoidance of hot cracks (see also the above account).

Moreover, in our own investigations it was found, surprisingly, that in many cases the tendency to for not cracks is even reduced when a noble-metal dental alloy according to the invention does rot contain any boron. This is particularly surprising, because the prior art has previously suggested that this is impossible. A noble-metal dental alloy according to the invention that is free from boron is therefore particularly preferred.

In a noble-metal dental alloy according to the invention for the SLM process the proportion of other elements is 0 through 2 wt. %. A noble-metal dental alloy according to the invention for the SLM process (as described above and preferably designated above as preferred) preferably comprises

| | |
|---|---|
| other elements in an amount of | 0 through 1.5 wt. %, |
| preferably | 0 through 1 wt. % |
| particularly preferably | 0 through 0.5 wt. %, |
| most preferably | 0 through 0.15 wt. %. |

“Other elements” are elements that are not cobalt, ruthenium, rhodium, palladium, osmium, iridium, platinum, chromium, molybdenum, tungsten, boron, niobium, tin, silicon, aluminum, tantalum, cerium, indium, vanadium, titanium, zirconium, hafnium, rhenium and manganese; usual other elements are for example other metals, semimetals and impurities. Typical “other elements” in a noble-metal dental alloy according to the invention are iron and nickel.

It has regularly been found in our own investigations that the proportion of “other elements” should not be greater than 2 wt. %, as otherwise the mechanical, biological and/or chemical properties are affected adversely. A person skilled in the art will therefore set the proportion of said “other elements” as low as possible. Most preferably, the proportion of “other elements” is 0 through 0.15 wt. %; in this concentration range, the “other elements” no longer affect the aforementioned properties to a relevant extent, in particular not when the proportions of the aforementioned elements that do not count as “other elements” are also in a preferred range (as defined above).

A noble-metal dental alloy according to the invention for the SLM process (as described above and preferably designated above as preferred) preferably comprises silicon in an amount from 0 through 0.25 wt. %, preferably in an amount from 0 through 0.1 wt. %, wherein the percentages by weight are in each case relative to the total weight of the noble-metal dental alloy.

A noble-metal dental alloy according to the invention for the SLM process (as described above and preferably designated above as preferred) preferably comprises gold as said or one of said other elements in an amount from 0 through 0.25 wt. %, preferably 0 through 0.1 wt. %, relative to the total weight of the noble-metal dental alloy.

A noble-metal dental alloy according to the invention for the SLM process (as described above and preferably designated above as preferred) preferably comprises aluminum in an amount from 0 through 0.4 wt. %, preferably in an amount from 0 through 0.25 wt. %, relative to the total weight of the noble-metal dental alloy.

A noble-metal dental alloy according to the invention for the SLM process (as described above and preferably designated above as preferred) preferably comprises cerium in an amount from 0 through 0.4 wt. %, preferably in an amount from 0 through 0.25 wt. %, most preferably in an amount from 0 through 0.1 wt. %, relative to the total weight of the noble-metal dental alloy.

A noble-metal dental alloy according to the invention for the SLM process (as described above and preferably designated above as preferred) preferably comprises carbon as said or one of said other elements in an amount from 0 through 0.3 wt. %, preferably in an amount from 0 through 0.2 wt. %, particularly preferably in an amount from 0 through 0.1 wt. %, relative to the total weight of the noble-metal dental alloy.

A noble-metal dental alloy according to the invention for the SLM process (as described above and preferably designated above as preferred) preferably comprises nitrogen as said or one of said other elements in an amount from 0 through 0.4 wt. %, preferably in an amount from 0 through 0.2 wt. %, particularly preferably in an amount from 0 through 0.1 wt. %, relative to the total weight of the noble-metal dental alloy.

In the context of the invention, the respective alloying constituents (as described above and preferably designated above as preferred) can be combined together in various amounts with formation of a noble-metal dental alloy according to the invention for the SLM process. The noble metals selected from the group consisting of ruthenium, rhodium, palladium, osmium, iridium and platinum (in particular palladium (Pd)) and the elements chromium (Cr), molybdenum (Mo), cobalt (Co) and the “other elements” and some of the elements selected from the group consisting of niobium, tin, silicon, aluminum, tantalum, cerium, indium, vanadium, titanium, zirconium, hafnium, rhenium and manganese are, in the context of the present invention, assigned graded preferred ranges (“preferred”, “particularly preferred”, “most preferred” etc.). For example, the percentage by weight of palladium is preferably 25 through 30 wt. % and the percentage by weight of chromium is particularly preferably 24 through 26 wt. %; the preferred percentage by weight of palladium and the particularly preferred percentage by weight of chromium can be combined. This also applies analogously to molybdenum, cobalt and the “other elements”, to which various preferred ranges are assigned, and to further possible combinations of the preferred ranges. Preferred embodiments of noble-metal dental alloys according to the invention (as described above and preferably designated above as preferred) relate correspondingly to all combinations of all preferred ranges of the elements and constituents contained that are available to a person skilled in the art.

In a noble-metal dental alloy according to the invention for the SLM process, the sum of 2.6 times the amount of molybdenum and 1.3 times the amount of tungsten and the amount of chromium is in the range from 40 through 50 wt. %. The sum of 2.5 times the amount of molybdenum and 1.3 times the amount of tungsten and the amount of chromium in a noble-metal dental alloy according to the invention as described above and preferably designated above as preferred) is preferably in the range from 42.5 through 49.5 wt. %.

| | |
|---|---|
| preferably in the range from | 45 through 49 wt. %, |
| particularly preferably in the range from | 47 through 49 wt. %. |

The determination of this sum is explained in the following example of calculation. In a particularly preferred embodiment of a noble-metal dental alloy according to the invention (see “Examples of compositions according to the invention”, example (11)), the proportion of chromium is for example 25.0 wt. %, the proportion of molybdenum 9.0 wt. %, the proportion of tungsten 0 wt. %. The sum of the proportions by weight is calculated as follows: 2.6 times the amount of molybdenum=2.6*9 wt. %=23.4 wt. %; 1.3 times the amount of tungsten=1.3*0 wt. %=0 wt. %; the single amount of chromium=1*25 wt. %=25 wt. %. The sum=23.4 wt. % (molybdenum)+0 wt. % (tungsten)+25 wt. % (chromium)=48.4 wt. % and is therefore in the aforementioned, particularly preferred range.

Additional investigations into the magnetic behavior of the noble-metal dental alloys according to the invention for the SLM process showed a slight, positive volume magnetic susceptibility. A noble-metal dental alloy according to the invention for the SLM process (as described above and preferably designated above as preferred) is preferred, wherein the alloy is paramagnetic.

An alloy is paramagnetic if the volume magnetic susceptibility (X) is greater than 0, but there is no ferromagnetism (also characterized by a positive volume susceptibility, but Which is significantly greater than the paramagnetism).

Therefore a paramagnetic noble-metal dental alloy according to the invention for the SLM process (as described above and preferably designated above as preferred) is preferred that consists of

| | |
|---|---|
| cobalt in an amount of | 36 through 46.5 wt. %, |
| | preferably 37 through 45 wt. %, |
| one, two or a plurality of noble | 25 through 30 wt. %, |
| metals selected from the group con- | preferably 25 through 28 wt. %, |
| sisting of ruthenium, rhodium, | |
| palladium, osmium, iridium and | |
| platinum, wherein the total amount of | |
| these noble metals is | |
| chromium in an amount of | 22.5 through 28 wt. %, |
| | preferably 23 through 27 wt. %, |
| one or both elements from the group | 6.5 through 10 wt. %, |
| consisting of molybdenum and | preferably 7 through 9.5 wt. %, |
| tungsten, wherein the total of the | |
| amount of molybdenum and half the | |
| amount of tungsten is | |
| boron in an amount of | 0 through 0.03 wt. % |
| | preferably 0 through 0.02 wt. % |
| | or |
| | 0.2 through 0.6 wt. % |
| | preferably 0.25 through 0.4 wt. %, |
| one, two, more than two or all | 0 through 0.3 wt. %, |
| elements selected from the group | preferably 0 through 0.2 wt. %, |
| consisting of niobium, tin, silicon, | |
| aluminum, tantalum, cerium, | |
| indium, vanadium, titanium, | |
| zirconium, hafnium, rhenium and | |
| manganese, wherein the total amount | |
| of these elements is | |
| one or a plurality of other elements | 0 through 1.5 wt. %, |
| in a total amount of | preferably 0 through 1.0 wt. %, |

with the proviso that the amount of gold as said or one of said other elements is in the range from 0 through 0.25 wt. %, preferably 0 through 0.1 wt. %,
wherein the percentages by weight are in each case relative to the total weight of the noble-metal dental alloy,
wherein the following is valid:
   the sum of 2.6 times the amount of molybdenum and 1.3 times the amount of tungsten and the amount of chromium is in the range from 40 through 50 wt. %, preferably in the range from 42.5 through 49.5 wt. %.

In a particularly preferred embodiment, a paramagnetic noble-metal dental alloy according to the invention for the SLM process (as described above and preferably designated above as preferred) consists of

| | |
|---|---|
| cobalt in an amount of | 40.5 through 42 wt. %, |
| palladium in an amount of | 25 through 25.5 wt. %, |
| chromium in an amount of | 24.0 through 25.5 wt. %, |
| molybdenum in an amount of | 8.5 through 9.2 wt. %, |
| tungsten in an amount of | 0 through 0.1 wt. %, |
| one, two, more than two or all elements | 0 through 0.1 wt. %, |
| selected from the group consisting of | |
| niobium, tin, silicon, aluminum, tantalum, | |
| cerium, indium, vanadium, titanium, | |
| zirconium, hafnium, rhenium and manganese, | |
| wherein the total amount of these elements is | |
| boron in an amount of | 0 through 0.005 wt. %, |
| other elements in a total amount of | 0 through 0.15 wt. %, |

wherein the percentages by weight are in each case relative to the total weight of the noble-metal dental alloy,
wherein the following is valid:
   the sum of 2.6 times the amount of molybdenum and 1.3 times the amount of tungsten and the amount of chromium is in the range from 47 through 49 wt. %.

Cf. Example alloy 11 of compositions according to the invention.

A particularly preferred paramagnetic noble-metal dental alloy according to the invention of this kind for the SLM process (as just described above) is regularly characterized by an extremely slight tendency to form hot cracks. In many cases said noble-metal dental alloys according to the invention possess a favorable CTE of 14.4 through 14.6 [10⁻⁶K⁻¹] in a range from 25 through 500° C., a tensile strength in the range from 800 through 1250 MPa, a proof stress (Rₚ 0.2) in the range from 700 through 1000 MPa, an elongation at is break of over 2%, a Vickers hardness HV 10 in the range from 300 through 380 and/or a melting range with solidus and liquidus temperature in each case in the range from 1260 through 1300° C. (wherein the difference Delta T_{L-S} (ΔT_{L-S}) between solidus and liquidus temperature is preferably only 25 K or less) (see also the above statements, which apply correspondingly).

In particularly preferred embodiments of a noble-metal dental alloy according to the invention for the SLM process (as described above and preferably designated above as preferred), the CTE is 14.2 through 14.7 [10⁻⁶K⁻¹], preferably 14.4 through 14.6 [10⁻⁶K⁻¹], wherein the CTE relates to a temperature range from 25 through 500° C.

In particularly preferred embodiments of a noble-metal dental alloy according to the invention for the SLM process (as described above and preferably designated above as preferred) the tensile strength is in a range from 700 through 1400 MPa, preferably in a range from 800 through 1250 MPa.

In particularly preferred embodiments of a noble-metal dental alloy according to the invention for the SLM process (as described above and preferably designated above as preferred) the proof stress (Rₚ 0.2) is in the range from 500 through 1200 MPa, preferably in the range from 700 through 1000 MPa.

In particularly preferred embodiments of a noble-metal dental alloy according to the invention for the SLM process (as described above and preferably designated above as preferred) the elongation at break is in the range from 2 through 25%, preferably the elongation at break is above 2%.

In particularly preferred embodiments of a noble-metal dental alloy according to the invention for the SLM process (as described above and preferably designated above as preferred) the HV 10 (Vickers hardness) is in the range from 280 through 480, preferably in the range from 300 through 400.

The aforementioned mechanical properties were determined on suitable test specimens (see examples, point 2.).

Particularly preferred noble-metal dental alloys according to the invention for the SLM process (as described above and preferably designated above as preferred) possess a melting range,

whose solidus and liquidus temperature is in each case in the range from 1150 through 1320° C., preferably in each case in the range from 1240 through 1310° C., particularly preferably in each case in the range from 1260 through 1300° C.,
and/or
wherein the difference Delta T_{L-S} (ΔT_{L-S}) between solidus and liquidus temperature is preferably only 70 K or less, more preferably is 60 K or less, particularly preferably is 40 K or less, in particular preferably is 25 K or less.

As already described above, a person skilled in the art knows appropriate methods for determining the aforementioned material properties (CTE, tensile strength, proof stress (Rₚ 0.2), elongation at break, HV 10 (Vickers hardness) and melting range) (the foregoing applies correspondingly).

A preferred noble-metal dental alloy according to the invention for the SLM process (as described above and preferably designated above as preferred) does not comprise boron and/or does not comprise tungsten. A corresponding preferred noble-metal dental alloy according to the invention (as described above and preferably designated above as preferred) is therefore in one of four embodiments: (i) comprising boron and not comprising tungsten or (ii) comprising boron and comprising tungsten, or (iii) not comprising boron and comprising tungsten or (iv) not comprising boron and not comprising tungsten.

If the noble-metal dental alloy according to the invention for the SLM process as described above and preferably designated above as preferred) comprises boron (embodiments (i) and (ii)), the percentage by weight of boron is less than or equal to 0.05 wt. %, preferably less than or equal to 0.03 wt. %, particularly preferably less than or equal to 0.02 wt. % or the percentage by weight of boron is in the range from 0.2 through 0.75 wt. %; preferably in the range from 0.2 through 0.6 wt. %, particularly preferably in the range from 0.25 through 0.4 wt. %. In a noble-metal dental alloy according to the invention, boron can be added to the alloy (a) as elemental boron, and/or (b) in the form of one or a plurality of boron-metal compounds (borides). The designation “boron” includes, in the sense of this invention, the proportion of boron in borides. A noble-metal dental alloy according to the invention that does not comprise boron is preferred. If a noble-metal dental alloy according to the invention for the SLM process (as described above and preferably designated above as preferred) comprises boron, the boron atoms are either dissolved in the alloy matrix (i.e. interstitially, thus at interstitial sites) or, at higher boron contents, as precipitates.

A noble-metal dental alloy according to the invention for the SLM process (as described above and preferably designated above as preferred) is preferred wherein the individual amount of the elements selected from the group consisting of niobium, tin, silicon, aluminum, tantalum, cerium, indium, vanadium, titanium, zirconium, hafnium, rhenium and manganese in each case is 0 through max. 0.1 wt. %, relative to the total weight of the noble-metal dental alloy. This means that in preferred embodiments, these selected elements (if they are present in a noble-metal dental alloy according to the invention) may be present individually up to a maximum amount of 0.1 wt. %, but for their total amount, the restrictions discussed above and hereunder have to be taken into account.

A noble-metal dental alloy according to the invention for the SLM process (as described above and preferably designated above as preferred) is preferred, wherein the total amount of the elements selected from the group consisting of niobium, tin, silicon, aluminum, tantalum, cerium, indium, vanadium, titanium, zirconium, hafnium, rhenium and manganese is 0 through to an overall maximum of 0.3 wt. %, preferably 0 through to an overall maximum of 0.2 wt. %, relative to the total weight of the noble-metal dental alloy.

Our own investigations have regularly shown that it is preferable that a noble-metal dental alloy according to the invention (as described above and preferably designated above as preferred) does not comprise as many as possible of the elements selected from the group consisting of niobium, tin, silicon, aluminum, tantalum, cerium, indium, vanadium, titanium, zirconium, hafnium, rhenium and manganese.

Therefore a noble-metal dental alloy according to the invention (as described above and preferably designated above as preferred) is preferred that does not comprise one, two, three, more than three or all of the elements selected from the group consisting of niobium, tin, silicon, aluminum, tantalum, cerium, indium, vanadium, titanium, zirconium, hafnium, rhenium and manganese, preferably does not comprise one two, three, more than three or all of the elements selected from the group consisting of niobium, tin, silicon, aluminum, tantalum, cerium, indium, vanadium, titanium, zirconium, hafnium, rhenium, manganese, gallium, carbon, nitrogen and gold.

Our own investigations have shown that elements selected from the group consisting of niobium, tin, silicon, aluminum, tantalum, cerium, indium, vanadium, titanium, zirconium, hafnium, rhenium and manganese, in particular if these elements are present in a noble-metal dental alloy according to the invention in a total amount above 0.5 wt. %, regularly give rise to an undesirably wide melting range. As already explained above in the text, a wide melting range is unfavorable for crack-free processing by an SLM process (the foregoing applies correspondingly).

Therefore it is particularly preferable if a noble-metal dental alloy according to the invention for the SLM process (as described above and preferably designated above as preferred) does not comprise any of the elements selected from the group consisting of niobium, tin, silicon, aluminum, tantalum, cerium, indium, vanadium, titanium, zirconium, hafnium, rhenium and manganese.

In selected embodiments, a noble-metal dental alloy according to the invention for the SLM process (as described above and preferably designated above as preferred) comprises gallium as said or one of said other elements in an amount from 0 through 2 wt. %, preferably 0 through 1 wt. %, particularly preferably 0 through 0.5 wt. % relative to so the total weight of the noble-metal dental alloy. Particularly preferably, a noble-metal dental alloy according to the invention for the SLM process does not comprise any gallium.

Our own investigations have shown that gallium in the aforementioned amounts regularly does not cause any significant impairment of the advantageous properties discussed above, in particular, gallium regularly does not give rise to any significant broadening of the melting range either.

According to another preferred embodiment, a noble-metal dental alloy according to the invention (as described above and preferably designated above as preferred) preferably does not comprise any ruthenium.

Another aspect of the present invention relates to a powder comprising or consisting of particles of a noble-metal dental alloy according to the invention for the SLM process (as described above and preferably designated above as preferred) for use in an SLM process (preferably in an SLM process with non-selective application of material, see the general statements made above and—regarding preferred configurations—the statements made below).

Preferred powders according to the invention for use in an SLM process (in particular an SLM process with non-selective application of material) have a grain size distribution in the range from 10 through 80 micrometers, preferably in the range from 10 through 53 micrometers, more preferably in the range from 10 through 45 micrometers (the permitted deviation from the given limits of the grain size distribution is in each case 3 wt. % above or below, i.e. 94 wt. % of the amount of powder is within the aforementioned limits for the grain size distribution).

Another aspect of the present invention relates to the use of a powder according to the invention (as described above and preferably designated above as preferred) from a noble-metal dental alloy according to the invention for the SLM process (as described above and preferably designated above as preferred) for producing a metallic component by an SLM process, preferably for producing a dental component as or for a dental restoration. A dental component “as dental restoration” is a component that is used directly for the restoration of a dental situation; in particular it is not veneered. A dental component “for a dental restoration” is, in contrast, submitted to one or a plurality of further processing steps and for example is used in conjunction with other components for a dental restoration; a typical example of a “dental component for a dental restoration” is a metallic structure for a dental restoration, which comprises the metallic structure and a ceramic veneer, which is fired to the structure.

It was found in our own investigations that the use according to the invention of a powder according to the invention (as described above and preferably designated above as preferred) for producing metallic components by an SLM process leads in many cases to crack free metallic components, which in addition regularly have excellent mechanical, chemical and biological properties (regarding the mechanical, chemical and biological properties, the foregoing applies). This has been confirmed in particular in the processing of the powder according to the invention by an SLM process (and taking account of the conditions in an SLM process stated in the text).

Another aspect of the present invention relates to a metallic component that can be produced by an SLM process, preferably a dental component as or for a dental restoration, more preferably a dental structure as or for a dental restoration, consisting of a noble-metal dental alloy according to the invention for the SLM process (as described above and preferably designated above as preferred).

Preferred metallic components according to the invention are dental restorations such as for example crowns, caps, bridges and prostheses or parts of prostheses. These dental restorations are either removable or fixed.

In another preferred embodiment, metallic components according to the invention are employed in medical engineering for example as surgical implants.

In further preferred embodiments, metallic components according to the invention are used or processed for application in motor vehicle parts, engines and engine components, power units and components of power units, tools and tool components and jewelry.

Another aspect of the present invention relates to a method for producing a metallic component, preferably a dental component as or for a dental restoration, more preferably a dental structure as or for a dental restoration, with the following steps:
providing a powder according to the invention (as described above and preferably designated above as preferred),
producing the metallic component, preferably the dental structure, wherein the powder is processed by selective laser melting.

It was found in our own investigations that by the method according to the invention, using the SLM process, it is possible to produce metallic components (as described above and preferably designated above as preferred) which in many cases are crack-free and in addition regularly have excellent mechanical, chemical and biological properties (regarding the mechanical, chemical and biological properties, the foregoing applies).

Methods according to the invention are preferred in which the powder according to the invention (as described above and preferably designated above as preferred) is processed by selective laser melting under inert gas. The working atmosphere is thus preferably at least almost oxygen-free, and the use of a nitrogen atmosphere is particularly preferred (i.e. the use of nitrogen as inert gas). It is, moreover, preferred that preheating of the powder bed takes place.

In our own investigations it was found, surprisingly, that the powder according to the invention (as described above and preferably designated above as preferred) comprising or consisting of particles of a noble-metal dental alloy according to the invention for the SLM process (as described above and preferably designated above as preferred) in many cases prevents the formation of hot cracks during an SLM process, or at least greatly reduces it in comparison with known powders not according to the invention (i.e. powders comprising or consisting of particles of a noble-metal dental alloy whose composition is not according to the invention).

A person skilled in the art will set suitable laser parameters for the SLM process, in order to process a powder according to the invention error-free into dental objects, preferably into a metallic component in the sense of the present invention. These include for example the layer thickness of application during the process and the laser power. An advantageous layer thickness is 20 through 40 micrometers. The laser power can be within a lower, middle or upper power range, when the lower power range denotes 50 through 100 W, the middle power range 100 through 150 W and the upper power range 150 through 200 W. In SLM processes, the middle power range (i.e. 100 through 150 W) is often preferred, as SLM processes that are carried out within the lower power range lead more often to porous dental objects. SLM processes that are carried out within the above power range lead more often to dental objects that have cracks, i.e. hot cracks, on their surfaces. The use of powders not according to the invention, which are not suitable for SLM processes, in an SLM process that is carried out within the middle power range, leads very frequently to dental objects that have both defects, i.e. an unacceptable porosity and hot cracks. Either cracks or pores predominate, depending on the precise setting of laser power within the middle power range (i.e. 100 through 150 W).

Suitable equipment for carrying out an SLM process is for example equipment of the type EOSINT M270 (EOS GmbH—Electro Optical Systems, Robert-Stirling-Ring 1, 82152 Krailling, Germany) or SLM 125^{HL} (SLM Solutions GmbH, Roggenhorster Strasse 9c, 23556 Lübeck, Germany).

A method according to the invention is preferred comprising the additional step:
firing of dental ceramic onto the metallic component, preferably the dental structure, wherein the dental ceramic has a CTE in the range from 12 through 14 [10⁻⁶K⁻¹], referring to a temperature range from 25 through 500° C.

In a preferred method according to the invention (as described above and preferably designated above as preferred), a dental ceramic with a CTE in the range from 12 through 14 [10⁻⁶K⁻¹] (relative to a temperature range from 25 through 500° C.) is fired to a metallic dental component according to the invention for a dental restoration, preferably onto a dental structure for a dental restoration. The resulting, ceramic-veneered component is or will be, after carrying out further treatment steps, a dental restoration. This includes e.g. crowns, bridges and prostheses.

Therefore the present disclosure also relates to a dental restoration comprising or consisting of
(i) a metallic component according to the invention, preferably a dental component for a dental restoration, more preferably a dental structure for a dental restoration, consisting of an alloy according to the invention for the SLM process (as described above and preferably designated above as preferred) and
(ii) a dental ceramic, fired to the metallic component according to the invention, preferably the dental component for a dental restoration, more preferably fired to a dental structure for a dental restoration,
wherein the dental ceramic has a CTE in the range from 12 through 14 [10⁻⁶K⁻¹].

The fired dental ceramic can be applied partially or completely on the metallic component according to the invention. The firing takes place according to methods that are known by a person skilled in the art, usually by means of opaque, 1^{st} and 2^{nd} opaque firing (see the account referring to the examples).

The method according to the invention (as described above and preferably designated above as preferred) is regularly particularly suitable for the production of a dental restoration (as described above, i.e. with dental ceramic fired to the metallic component according to the invention), as the metallic component according to the invention, preferably the dental component for a dental restoration, more preferably the dental structure for a dental restoration itself has a favorable coefficient of thermal expansion (CTE). The CTE of metallic components according to the invention (as described above and preferably designated above as preferred) is regularly in a favorable and desirable compatibility range with the CTE of preferred dental ceramics.

In practice it is favorable if the CTE of the ceramic is somewhat lower than the CTE of the alloy to be veneered, which is suitable for veneering (i.e. the CTE of the metallic component according to the invention). In this way, after cooling, a required compressive stress can develop in the dental ceramic. If the coefficients of thermal expansion (CTEs) of the alloy and of the dental ceramic are not optimally matched, there is often fissuring or chipping in the ceramic.

The CTE of metallic components according to the invention (as described above and preferably designated above as preferred) is regularly in a favorable range from 14.1 through 14.9 [10⁻⁶K⁻¹](in a range from 25 through 500° C.) and is thus somewhat higher than the CTE of advantageous dental ceramics (12 through 14 [10⁻⁶K⁻¹], in a range from 25 through 500° C.).

Ceramic-veneered dental restorations according to the invention regularly exhibit, as a result of the favorable compatibility with respect to the CTE of alloy and corresponding dental ceramic (in the range from 25 through 500° C.), particularly good properties, for example with respect to the durability and life of the ceramic-veneered metallic component.

In the firing of dental ceramics, the alloy according to the invention has the following advantages:
(i) As a rule it is not necessary to carry out an oxidation firing, which is usually required for noble-metal dental alloys to produce a sufficiently developed adherent oxide layer before the step of ceramic veneering.
(ii) Owing to the good match of the CTE of the alloy (metallic component) with the commonly commercially available dental ceramics, as a rule slow cooling is unnecessary.
(iii) There is favorable bonding to the common ceramics, presumably because chromium and molybdenum act as adherent oxide formers and are present in very high concentration in the alloy composition according to the invention and furthermore are in a favorable ratio to one another.
(iv) High-temperature strength is adequate, so that during ceramic veneering there is no distortion owing to the alloy structure's own weight.

The invention is described in more detail below on the basis of examples:

### EXAMPLES

### 1. Compositions of Examples of Alloys According to the Invention

All the numerical data in Table 1 are percentages by weight and refer to the total weight of the respective noble-metal dental alloy according to the invention for the SLM process.

TABLE 1
Examples of compositions according to the invention

| Alloy | Co | Pd | Ru | Pt | Cr | Mo | W | B |
|---|---|---|---|---|---|---|---|---|
| (1) | 42.3 | 25 | 0 | 0 | 22 | 10.7 | 0 | 0 |
| (2) | 41 | 25 | 0 | 0 | 24 | 10 | 0 | 0 |
| (3) | 41.5 | 25 | 0 | 0 | 23.5 | 10 | 0 | 0 |
| (4) | 43 | 25 | 0 | 0 | 22 | 10 | 0 | 0 |
| (5) | 40.5 | 25 | 0 | 0 | 25 | 9.5 | 0 | 0 |
| (6) | 41.5 | 25 | 0 | 0 | 24 | 9.5 | 0 | 0 |
| (7) | 42.5 | 25 | 0 | 0 | 23 | 9.5 | 0 | 0 |
| (8) | 43.5 | 25 | 0 | 0 | 22 | 9.5 | 0 | 0 |
| (9) | 39.5 | 25 | 0 | 0 | 26.5 | 9 | 0 | 0 |
| (10) | 40 | 25 | 0 | 0 | 26 | 9 | 0 | 0 |
| (11) | 41 | 25 | 0 | 0 | 25 | 9 | 0 | 0 |
| (12) | 44 | 25 | 0 | 0 | 22 | 9 | 0 | 0 |
| (13) | 38 | 25 | 0 | 0 | 29 | 8 | 0 | 0 |
| (14) | 39 | 25 | 0 | 0 | 28 | 8 | 0 | 0 |
| (15) | 40 | 25 | 0 | 0 | 27 | 8 | 0 | 0 |
| (16) | 41 | 25 | 0 | 0 | 26 | 8 | 0 | 0 |
| (17) | 42 | 25 | 0 | 0 | 25 | 8 | 0 | 0 |
| (18) | 45 | 25 | 0 | 0 | 22 | 8 | 0 | 0 |
| (19) | 39 | 25 | 0 | 0 | 29 | 7 | 0 | 0 |
| (20) | 43 | 25 | 0 | 0 | 25 | 7 | 0 | 0 |
| (21) | 46 | 25 | 0 | 0 | 22 | 7 | 0 | 0 |
| (22) | 40 | 25 | 0 | 0 | 29 | 6 | 0 | 0 |
| (23) | 42 | 25 | 0 | 0 | 27 | 6 | 0 | 0 |
| (24) | 43 | 25 | 0 | 0 | 26 | 6 | 0 | 0 |
| (25) | 44 | 25 | 0 | 0 | 25 | 6 | 0 | 0 |
| (26) | 40.5 | 25 | 0 | 0 | 25 | 8 | 1.5 | 0 |
| (27) | 41 | 25 | 0 | 0 | 25 | 8.5 | 0.5 | 0 |
| (28) | 40.75 | 25 | 0 | 0 | 25 | 8.5 | 0 | 0.75 |
| (29) | 41.5 | 15 | 0 | 10 | 25 | 8.5 | 0 | 0 |
| (30) | 41 | 24 | 0 | 1 | 25 | 9 | 0 | 0 |
| (31) | 41.5 | 17.5 | 7.5 | 0 | 25 | 8.5 | 0 | 0 |

Table 2 shows, for comparison, noble-metal dental alloys not according to the invention. Ail numerical data in Table 2 are percentages by weight and refer to the total weight of the respective alloy.

TABLE 2
Examples of compositions not according to the invention,
whose test specimens have hot cracks/hot cracking

| Alloy | Co | Pd | Ru | Pt | Au | Cr | Mo | W | B |
|---|---|---|---|---|---|---|---|---|---|
| (32) | 39.25 | 25 | 0 | 0 | 0 | 25 | 10.5 | 0 | 0.25 |
| (33) | 39.5 | 25 | 0 | 0 | 0 | 25 | 10.5 | 0 | 0 |
| (34) | 40.85 | 25 | 0 | 0 | 0 | 25 | 9 | 0 | 0.15 |
| (35) | 41 | 22.25 | 2 | 0 | 0.75 | 25 | 9 | 0 | 0 |

### 2 Production of Metallic Components According to the Invention

(i) 2×6 round tensile bars (according to ISO 22674), (ii) 8 flat tensile bars (profile according to diameter of the round tensile bars (i.e. according to ISO 22674) and with a thickness of 0.6 mm) and (iii) 2 CTE-bars (according to ISO 9693) were produced by a method with the following steps:
Providing a powder of particles of the alloy (1, see Table 1) with a grain size distribution from 10 through 45 micrometers.
Producing the metallic component, by processing the particles of the powder in an SLM process using equipment of the SLM 125^{HL} type (from SLM Solutions GmbH, inert gas: nitrogen). The particles of the powder are applied in a layer thickness of 30 micrometers and then selectively melted at a laser power from 120 through 200 W in the volume range of the components (i.e. for example taking account of the information on geometry of a flat tensile bar or CTE-bar).

The procedure of the above method of producing metallic components according to the invention was repeated, each time using a powder of a different alloy (i.e. a powder of alloys (2) through (35)).

The respective resultant (i) 2×6 round tensile bars, (ii) 8 flat tensile bars and (iii) 2 CTE-bars, produced from the powder of the alloy (11), were then investigated for their mechanical properties (with the round tensile bars), CTE values (with the CTE-bars) melting ranges (using component residues) and hot cracks (with the flat tensile bars). The mechanical properties, CTE values and the melting range are presented in Table 3 (see 3.2). Results for investigation of hot cracks are presented in section 3.1.

The flat tensile bars that were produced from the powders of allays (1) through (10) and (12) through (35) were also investigated for the presence of hot cracks (see the account in section 3.1).

### 3. Material Properties of Metallic Components According to the Invention

### 3.1 Investigation for Hot Cracks

The investigation for hot cracks was carried out on completion of the respective SLM process and before separating the corresponding flat tensile bars from their construction platforms (regarding the corresponding investigation, see also the account given above in the text). In a first inspection step, the components were first examined by eye for cracks/tears/hot cracks. In a 2nd inspection step the components were examined by microscope at up to 100-times magnification. The number of detected cracks was (regardless of their length) recorded and evaluated.

Flat tensile bars, produced from the powder of the alloy (11), did not have any hot cracks. This also applies in particular to flat tensile bars that were produced from the powders of alloys (4), (6), (7), (8), (12), (14)-(31).

Flat tensile bars produced from powders of alloys (3) and (10) had only occasional hot cracks.

Flat tensile bars produced from the powders of alloys (1), (2), (5), (9) and (13) had hardly any hot cracks.

In contrast, flat tensile bars produced from powders of alloys (32) through (35) regularly had hot cracks.

If individual hot cracks were observed, these occurred in each case on the side facing the construction platform (in the transition from the shoulder to the measurement zone: i.e. at the beginning or end of the central, 3 mm thick region with a length of 18±0.1 mm).

The number of hot cracks was surprisingly small for each type of flat tensile bars investigated, in comparison with flat tensile bars from conventional alloys.

### 3.2 Mechanical Properties and Melting Ranges of Metallic Components According to the Invention:

The material properties given below were determined on the round tensile bars and CTE-bars produced in section 2. (“Production of metallic components according to the invention”), which had been produced from the powder of the alloy (11).

The following material properties are presented in Table 3.
mechanical properties (Vickers hardness (HV 10), proof stress (Rₚ 0.2), tensile strength, elongation at break and CTE), wherein the values for proof stress (Rₚ 0.2), tensile strength and elongation at break refer to the fired state according to ISO 22674.
melting range

Regarding determination of the material properties, see the account in the text above.

The value given for “melting range” relates to the temperature range with the limits of solidus temperature (T_{S}) and liquidus to (T_{L}), wherein the low temperature corresponds to the solidus temperature (T_{S}), and the high temperature corresponds to the liquidus temperature (T_{L}).

The value given for “Δ_{L-S}” (Delta T_{L-S}) relates to the temperature difference between solidus temperature (T_{S}) and liquidus temperature (T_{L}); it therefore corresponds to the width of the melting range.

TABLE 3
Mechanical properties of round tensile bars, produced from the powder of the alloy (11)

| | | Proof | Tensile | Elongation | CTE | Melting | |
|---|---|---|---|---|---|---|---|
| | | stress | strength | at break | [10⁻⁵/K] | range | (Δ T_{L-S}) |
| Alloy | HV 10 | [MPa] | [MPa] | [%] | (25-500° C./20-600° C.) | [° C.] | [K] |
| (11) | 360 | 850 | 1050 | 10 | 14.5/14.9 | 1275-1290 | 15 |

### 4. Practical Example

### 4.1 Production of an 8-Unit Bridge Structure:

An 8-unit bridge structure was produced by a method comprising the following steps:
Providing a CAD/CAM dataset for the 8-unit bridge structure, which was produced on the basis of a real patient situation. The minimum wall thickness was in each case 0.3 mm. The anatomical shape was already taken into account, so that the main part of the restoration consisted of metal later on, i.e. after manufacture by SLM.
Providing a powder of particles of the alloy (11) with a particle size distribution in the range from 10 through 45 micrometers.
Producing the 8-unit bridge structure, by processing the particles of the powder in an SLM process using equipment of the EOSINT M270 type (inert gas: nitrogen). The particles of the powder were applied in a layer thickness of 30 micrometers and were then melted selectively at a laser power of 150-200 W (i.e. taking account of the information on the geometry of an 8-unit bridge structure).

After removing the construction platform from the EOSINT M270, the powder residues were removed roughly by mechanical means. Then the bridge structure produced was separated from the construction platform and the surface was machined with a fine-toothed hard-metal milling cutter, in order to (i) remove residues of the supports (i.e. the “supporting structure” between bridge and construction platform), (ii) remove melted beads from the surface and (iii) to smooth the region of the edges of the bridge if necessary. The 8-unit bridge structure produced had excellent machinability. Owing to this excellent machinability, the dental technician's work proved to be very pleasant, despite the relatively high hardness of the material. Finally the bridge structure was sandblasted with corundum of grain size 250 μm (Korox® 250/from SEGO) at 3 bar.

4.2 Veneering the 8-Unit Bridge Structure with Dental Ceramic by 1^{st} and 2^{nd} Opaque Firing:

Before the ceramic veneering, the surface of the bridge structure (see 4.1, above) was once again sandblasted, as described in 4.1, and steam cleaned, to condition the surface for subsequent 1^{st} opaque firing.

1^{st} opaque firing was carried out after applying a thin suspension of a veneering ceramic of the Ceramco 3 type (from Dentsply). The application was not opaque.

Then, after applying an opaque layer of paste opaque of the Ceramco 3 type (from Dentsply), 2^{nd} opaque firing was carried out.

For carrying out the 1^{st} opaque firing and the 2^{nd} opaque firing, unless stated otherwise, the procedure according to the processing instructions of the ceramic manufacturer (Dentsply) was followed. The temperatures and times shown in the table given below were used. The firing furnace was a Vakumat 6000 M (from Vita).

Stow cooling was not used—normal (i.e. comparatively rapid) cooling was carried out. Despite the normal cooling, surprisingly no fissuring or chipping occurred, not even after being left to stand for quite a long time (over 3 days). With the normal cooling, the dental technician was able to save approx. 10 min time per firing. Use of the alloy given above therefore makes very economical working possible.

In the method described, oxide firing (before the 1^{st} opaque firing) was omitted. This can, however, be carried out additionally, to verify the quality of the surface. If the surface quality is adequate, no shadowing should be seen, rather the oxide layer must have a uniform color. Before the next firings, the oxide layer must again be carefully removed by sandblasting.

Firings of the type “shoulder firing with margin” and “glaze firing with accent fluid” (after the 2^{nd} opaque firing) were omitted in the context of this example. These firings can, however, be carded out additionally.

According to the following Table 3, the following firings were carried out additionally: 1st dentine firing, 2nd dentine firing, correction firing and glaze firing. Once again, ceramic materials of the Ceramco 3 type (from Dentsply) were used.

The bond strength was determined in in-vitro tests (knock-off test and bending test according to DIN EN ISO 9693:2000). All requirements were far exceeded.

TABLE 4

| | Preheat | Time: | Heating | Final | | |
|---|---|---|---|---|---|---|
| | temper- | drying/ | rate | temper- | Holding | Vacuum, |
| | ature | preheat | [° C./ | ature | time | from-to |
| Firing | [° C.] | [min] | min] | [° C.] | [min] | [° C.] |
| 1^{st} | 500 | 5/3 | 100 | 975 | 0 | 500-975 |
| opaque | | | | | | |
| firing | | | | | | |
| 2^{nd} | 650 | 3/3 | 70 | 970 | 0 | 650-970 |
| opaque | | | | | | |
| firing | | | | | | |
| 1st | 650 | 5/5 | 55 | 960 | 0 | 650-960 |
| dentine | | | | | | |
| firing | | | | | | |
| 2nd | 650 | 5/5 | 55 | 960 | 0 | 650-960 |
| dentine | | | | | | |
| firing | | | | | | |
| Correction | 650 | 5/5 | 55 | 960 | 0 | 650-960 |
| firing | | | | | | |
| Glaze | 650 | 3/3 | 70 | 945 | 0.5 | — |
| firing | | | | | | |

1. A noble-metal dental alloy for the SLM process, comprising of

| | |
|---|---|
| cobalt in an amount of | 36 through 47 wt. %, |
| one, two or a plurality of noble metals | 25 through 35 wt. %, |
| selected from the group consisting of | |
| ruthenium, rhodium, palladium, osmium, | |
| iridium and platinum, wherein the | |
| total amount of these noble metals is | |
| chromium in an amount of | 22 through 29 wt. %, |
| one or both elements from the group | 6 through 11 wt. %, |
| consisting of molybdenum and tungsten, | |
| wherein the total of the amount of | |
| molybdenum and half the amount of tungsten is | |
| boron in an amount of | 0 through 0.05 wt. % |
| | or |
| | 0.2 through 0.75 wt. %, |
| one, two, more than two or all elements | 0 through 0.5 wt. %, |
| selected from the group consisting of | |
| niobium, tin, silicon, aluminum, tantalum, | |
| cerium, indium, vanadium, titanium, | |
| zirconium, hafnium, rhenium and manganese, | |
| wherein the total amount of these elements is | |
| and | 0 through 2 wt. %, |
| one or a plurality of other elements | |
| in a total amount of | |

wherein the percentages by weight are in each case relative to the total weight of the noble-metal dental alloy,
wherein the following is valid:
the sum of 2.6 times the amount of molybdenum and 1.3 times the amount of tungsten and the amount of chromium is in the range from 40 through 50 wt. %.

2. The noble-metal dental alloy for the SLM process as claimed in claim 1, wherein
the weight ratio of molybdenum to tungsten is greater than 2:1, preferably is greater than 10:1, particularly preferably is greater than 50:1,
and/or
the proportion of tungsten in the noble-metal dental alloy is less than 6 wt. %, preferably is less than 3 wt. %, particularly preferably is less than 1 wt. %, quite particularly preferably is in the range from 0 through 0.4 wt. %.

3. The noble-metal dental alloy for the SLM process as claimed in claim 1, comprising of

| | |
|---|---|
| cobalt in an amount of | 36 through 46.5 wt. %, |
| | preferably 37 through 45 wt. %, |
| and/or | 25 through 30 wt. %, |
| one, two or a plurality of noble metals | preferably 25 through 28 wt. %, |
| selected from the group consisting of | |
| ruthenium, rhodium, palladium, | |
| osmium, iridium and platinum, wherein | |
| the total amount of these noble metals is | |
| and/or | 22.5 through 28 wt. %, |
| chromium in an amount of | preferably 23 through 27 wt. %, |
| and/or | 6.5 through 10 wt. %, |
| one or both elements from the group | preferably 7 through 9.5 wt. %, |
| comprising of molybdenum and | |
| tungsten, wherein the total of the | |
| amount of molybdenum and half the | |
| amount of tungsten is | |
| and/or | 0 through 1.5 wt. %, |
| a total amount of the one or the | preferably 0 through 1 wt. %, |
| several other elements in the range from | |

wherein the percentages by weight are in each case relative to the total weight of the noble-metal dental alloy.

4. The noble-metal dental alloy for the SLM process as claimed in claim 1, wherein the proportion of palladium in the noble metals selected from the group consisting of ruthenium, rhodium, palladium, osmium, iridium and platinum is greater than 50 wt. %, preferably greater than 75 wt. %, particularly preferably greater than 95 wt. % and in particular preferably is in a range from 99.9 through 100 wt. %, relative to the total weight of said noble metals in the noble-metal dental alloy.

5. The noble-metal dental alloy for the SLM process as claimed in claim 1, comprising

| | |
|---|---|
| palladium in an amount of | 25 through 33.5 wt. %, |
| preferably | 25 through 30 wt. %, |
| particularly preferably | 25 through 28 wt. %, |
| most preferably | 25 through 25.5 wt. %. |

6. The noble-metal dental alloy for the SLM process as claimed in claim 1, wherein the alloy is paramagnetic.

7. A paramagnetic noble-metal dental alloy for the SLM process, as claimed in claim 1, comprising of

| | |
|---|---|
| cobalt in an amount of | 36 through 46.5 wt. %, |
| | preferably 37 through 45 wt. %, |
| one, two or more noble metals | 25 through 30 wt. %, |
| selected from the group comprising | preferably 25 through 28 wt. %, |
| of ruthenium, rhodium, palladium, | |
| osmium, iridium and platinum, | |
| wherein the total amount of these | |
| noble metals is | |
| chromium in an amount of | 22.5 through 28 wt. %, |
| | preferably 23 through 27 wt. %, |
| one or both elements from the group | 6.5 through 10 wt. %, |
| comprising of molybdenum and | preferably 7 through 9.5 wt. %, |
| tungsten, wherein the total of the | |
| amount of molybdenum and half the | |
| amount of tungsten is | |
| boron in an amount of | 0 through 0.03 wt. % |
| | preferably 0 through 0.02 wt. % |
| | or |
| | 0.2 through 0.6 wt. % |
| | preferably 0.25 through 0.4 wt. %, |
| one, two, more than two or all | 0 through 0.3 wt. %, |
| elements selected from the group | preferably 0 through 0.2 wt. %, |
| comprising of niobium, tin, silicon, | |
| aluminum, tantalum, cerium, indium, | |
| vanadium, titanium, zirconium, | |
| hafnium, rhenium and manganese, | |
| wherein the total amount of these | |
| elements is | |
| one or a plurality of other elements | 0 through 1.5 wt. %, |
| in a total amount of | preferably 0 through 1.0 wt. %, |

with the proviso that the amount of gold as said or one of said other elements is in the range from 0 through 0.25 wt. %, preferably 0 through 0.1 wt. %,
wherein the percentages by weight are in each case relative to the total weight of the noble-metal dental alloy,
wherein the following is valid:
the sum of 2.6 times the amount of molybdenum and 1.3 times the amount of tungsten and the amount of chromium is in the range from 40 through 50 wt. %, preferably in the range from 42.5 through 49.5 wt. %.

8. The paramagnetic noble-metal dental alloy for the SLM process, as claimed in claim 1, comprising of

| | |
|---|---|
| cobalt in an amount of | 40.5 through 42 wt. %, |
| palladium in an amount of | 25 through 25.5 wt. %, |
| chromium in an amount of | 24.0 through 25.5 wt. %, |
| molybdenum in an amount of | 8.5 through 9.2 wt. %, |
| tungsten in an amount of | 0 through 0.1 wt. %, |
| one, two, more than two or all elements | 0 through 0.1 wt. %, |
| selected from the group consisting of | |
| niobium, tin, silicon, aluminum, tantalum, | |
| cerium, indium, vanadium, titanium, | |
| zirconium, hafnium, rhenium and manganese, | |
| wherein the total amount of these elements is | |
| boron in an amount of | 0 through 0.005 wt. %, |
| other elements in a total amount of | 0 through 0.15 wt. %, |

wherein the percentages by weight are in each case relative to the total weight of the noble-metal dental alloy,
wherein the following is valid:
the sum of 2.6 times the amount of molybdenum and 1.3 times the amount of tungsten and the amount of chromium is in the range from 47 through 49 wt. %.

9. A powder for use in an SLM process comprising of particles of a noble-metal dental alloy as claimed in claim 1.

10. A use of a powder as claimed in claim 9 for producing a metallic component by an SLM process, preferably for producing a dental component as or for a dental restoration.

11. A metallic component that can be produced by an SLM process, preferably dental component as or for a dental restoration, more preferably dental structure as or for a dental restoration, comprising of a noble-metal dental alloy as claimed in claim 1.

12. A method of producing a metallic component, preferably a dental component as or for a dental restoration, more preferably a dental structure as or for a dental restoration, with the following steps:
providing a powder as claimed in claim 9 from a noble-metal dental alloy as claimed in claim 1,
producing the metallic component, preferably the dental structure, wherein the powder is processed by selective laser melting.

13. The method as claimed in claim 12, comprising the additional step:
firing of dental ceramic onto the metallic component, preferably the dental structure, wherein the dental ceramic has a CTE in the range from 12 through 14 [10⁻⁶K⁻¹], referred to a temperature range from 25 through 500° C.
